(19) United States
(12) Patent Application Publication
(10) Pub. No.: US 2023/0351198 A1
(43) Pub. Date: Nov. 2, 2023

(54) SYSTEM FOR DETECTING HIERARCHICAL NETWORK INTRUSION USING HIDDEN LAYER INFORMATION OF AUTOENCODER AND METHOD THEREOF

(71) Applicant: FOUNDATION OF SOONGSIL UNIVERSITY- INDUSTRY COOPERATION, Seoul (KR)

(72) Inventors: Minhae KWON, Seoul (KR); Hyoseon KYE, Seoul (KR); Miru KIM, Seoul (KR)

(73) Assignee: FOUNDATION OF SOONGSIL UNIVERSITY-INDUSTRY COOPERATION, Seoul (KR)

(21) Appl. No.: 17/979,728

(22) Filed: Nov. 2, 2022

(30) Foreign Application Priority Data
Apr. 28, 2022 (KR) 10-2022-0052839

(51) Int. Cl. G06N 3/091; H04L 9/40; G06N 3/0455

(52) U.S. Cl. CPC G06N 3/091; H04L 63/1425; G06N 3/0455

(57) ABSTRACT

The present disclosure provides a hierarchical network intrusion detection method including preprocessing normal data for training, outputting reconstruction data by inputting the preprocessed normal data for training into an autoencoder, calculating a reconstruction error by using the preprocessed normal data for training and the reconstruction data, training the autoencoder to minimize a reconstruction error, extracting hierarchical information of the autoencoder, setting a threshold value by using latent vector for the normal data for training, the reconstruction data, and an output value of each of L hidden layers included in an encoder, calculating anomaly scores of the latent vector for the network data, the reconstruction data, and an output value of each of the L hidden layers in a state in which a target network data is input to the autoencoder, and determining whether an intrusion into the network data is detected by using the threshold value and the anomaly scores.

### CROSS-REFERENCE TO RELATED APPLICATION

This application is based on and claims priority under 35 U.S.C. § 119 to Korean Patent Application No. 10-2022-0052839, filed on Apr. 28, 2022, in the Korean Intellectual Property Office, the disclosure of which is incorporated by reference herein in its entirety.

### BACKGROUND

### 1. Field

The present disclosure relates to a hierarchical network intrusion detection system using hidden layer information of an autoencoder and a method thereof, and particularly, to a hierarchical network intrusion detection system which uses hidden layer information of an autoencoder and determines whether an intrusion into network data is detected by using an anomaly score for each of a plurality of hidden layers, and a method thereof.

### 2. Description of the Related Art

Recently, the amount of internet traffics has sharply increased since onset of the COVID-19 pandemic, and thereby, cyber attack and a network intrusion increase.

Generally, experts analyze traffic and logs collected through IDS to identify the exact cause and pattern of the attack.

There is a problem in that it takes several days to several months to analyze cause of the attack by using a method of analyzing the traffic and logs.

Accordingly, in order to solve the problem of intrusion detection, research on automating intrusion detection by using an artificial neural network model is in progress.

Here, an autoencoder is an artificial neural network model based on a self-supervised training method, and it is possible to learn unlabeled data and to compressively extract characteristics of training data through training of the model.

In this case, the autoencoder includes an encoder and a decoder, the encoder reduces the input data to a low-dimensional latent space with only meaningful information, and the decoder reconstructs the reduced data to generate reconstruction data of the same dimension as input data.

The related art may not reflect all types of training information of an autoencoder only with input data and output data, and there is a limitation in that information of hidden layers in the autoencoder may not be utilized.

In addition, the autoencoder includes a hidden layer between the input data and the output data, and the hidden layer includes training information for anomaly detection. However, a detection time is fixed after passing through all the hidden layers, and thus, there is a problem in that efficiency is low due to several calculations performed for the data having a relatively large degree of abnormality until the detection time.

A technology underlying the present disclosure is disclosed in Korean Patent Application Publication No. 10-2279983 (published on Jul. 21, 2021).

### SUMMARY

The present disclosure provides a hierarchical network intrusion detection system which uses hidden layer information of an autoencoder and determines whether an intrusion into network data is detected by using an anomaly score for each of a plurality of hidden layers, and a method thereof

According to an aspect of the present disclosure, a hierarchical network intrusion detection method using a hierarchical network intrusion detection system based on hidden layer information of an autoencoder comprising, normalizing and preprocessing normal data for training in a state in which the normal data for training is collected, outputting reconstruction data by inputting the preprocessed normal data for training into the autoencoder including an encoder and a decoder, calculating a reconstruction error by using the preprocessed normal data for training and the reconstruction data, training the autoencoder to minimize a reconstruction error value, extracting hierarchical information of the trained autoencoder, setting a threshold value for the normal data for training by using latent vector for the normal data for training, the reconstruction data, and an output value of each of L hidden layers included in the encoder, calculating anomaly scores of the latent vector for the network data, the reconstruction data, and an output value of each of the L hidden layers included in the encoder in a state in which a target network data is input to the autoencoder, and determining whether an intrusion into the network data is detected by using the threshold value and the anomaly scores.

The outputting of the reconstruction data by inputting the preprocessed normal data for training into the autoencoder may include outputting latent vector by inputting the preprocessed normal data for training into the encoder, and outputting the reconstruction data by inputting the latent vector to the decoder.

In the calculating of the reconstruction error, the reconstruction error may be calculated by using the preprocessed normal data for training for a training process, the reconstruction data of the decoder for the preprocessed normal data for training, and a mean squared error (MSE) loss function and by using an equation which is

$$J ( {X}_{nor} , {\hat{X}}_{nor} ) = \frac{1}{N} {\sum }_{n = 1}^{N} {( {x}_{nor , n} - {\hat{x}}_{nor , n} )}^{2}$$

where, J is a loss function, Xₙₒᵣ is preprocessed normal data set for training, \hat{X}ₙₒᵣ is the reconstruction data for a preprocessed normal dataset for training, N is the number of data samples of the normal dataset for training, xₙₒᵣ is an N-th sample of Xₙₒᵣ, and \hat{x}_{nor,n} is an N-th sample of \hat{X}ₙₒᵣ.

The training of the autoencoder may include training the encoder by setting the preprocessed normal data for training as input data of the encoder and setting the latent vector as output data of the encoder, training the decoder by setting the latent vector as input data of the decoder and setting the reconstruction data as output data of the decoder, and training the autoencoder to minimize the reconstruction error value by using an error value between the preprocessed normal data for training and the reconstruction data.

In the setting of the threshold, based on the anomaly scores of the latent vector for the normal data for training, the reconstruction data, and the output value of each of the L hidden layers included in the encoder, the threshold value may be set to minimize a fall-out rate for normal data for each of the other hidden layers except for a last L-th hidden layer among the L hidden layers included in the encoder, the threshold value may be set to maximize a detection rate of abnormal data of the last L-th hidden layer.

In the calculating of the anomaly scores, the anomaly score of the latent vector for the network data may be calculated by using an equation which is ∈₁(x)= [symbol] _{MD}=\sqrt{(h−μₙₒᵣ)^{T}Σₙₒᵣ⁻¹(h−μₙₒᵣ)} where ∈ is an anomaly score of randomly input network data, [symbol] _{MD} is a measurement value of Mahalanobis distance (MD), h is latent vector of an encoder for network data, μₙₒᵣ is an average of latent vector of an encoder to which normal data for training is input, Σₙₒᵣ is a latent vector covariance of normal data for training, and T denotes a transpose matrix.

In the calculating of the anomaly scores, the reconstruction error used to calculate the anomaly score of the reconstruction data for the network data may be calculated by using an equation which is

$${d}_{l} = \{ \begin{matrix}x - \hat{x} & ( l = 0 ) \\ {g}_{: l} ( x ) - {g}_{: l} ( \hat{x} ) & ( 0 < l \leq L )\end{matrix}$$

where dₗ is a reconstruction error used for calculating the anomaly score, l denotes a position at which the reconstruction error is obtained and denotes an output part of the decoder when l=0 and denotes l-th hidden layer part of the encoder when 0<l≤L, x is a preprocessed input data sample, \hat{x} is reconstruction data for x, and g_{:l} denotes calculation up to the l-th hidden layer.

In the calculating of the anomaly scores, variables for calculating the anomaly scores of the network data may be calculated by using an equation which is

D₀=Xₙₒᵣ−\hat{X}ₙₒᵣ

μ₀= [symbol] (D₀)

D̅₀=D₀− [symbol] _{N×1}×μ₀

D̅₀=U₀\tilde{Σ}₀V₀⁻¹

where, μ₀^{T} is an average of reconstruction errors corresponding to error values between input data for normal dataset for training and the reconstruction data, V₀ is a right singular vector obtained by performing a singular value decomposition calculation of D̅₀ that is linearly shifted such that an average of a reconstruction error D₀ of the normal dataset for training and a reconstruction dataset of the normal dataset for training becomes 0, and \tilde{Σ}₀⁻¹ denotes a singular value obtained by the singular value decomposition calculation, and the variables are collected during extraction of the hierarchical information of the trained autoencoder.

In the calculating of the anomaly scores, the anomaly score of the output value of the decoder for the network data may be calculated by using an equation which is ∈₂(x)=L_{NL1}(d₀)=∥(d₀−μ₀^{T})^{T}V₀\tilde{Σ}₀⁻¹∥₁ where, [symbol] _{NL1} is a value measured by the normalized L1-norm method, d₀ is reconstruction errors corresponding to error values between network data and reconstruction data of the network data, and μ₀^{T} is an average of reconstruction errors corresponding to error values between input data of the normal dataset for training and reconstruction data.

In the calculating of the anomaly scores, variables for calculating the anomaly scores for the network data may be calculated by using an equation which is

Dₗ=g_{:l}(Xₙₒᵣ)−g_{:l}(\tilde{X}ₙₒᵣ)

μₗ= [symbol] (Dₗ)

D̅ₗ=Dₗ− [symbol] _{N×1}×μ₁

D̅ₗ=Uₗ\tilde{Σ}ₗVₗ⁻¹

where, μₗ^{T} is an average of reconstruction errors of the l-th hidden layer for a normal dataset for training, Vₗ is a right singular vector obtained by performing a singular value decomposition calculation of D̅ₗ that is linearly shifted such that an average of reconstruction errors of Dₗ the l-th hidden layer of a normal dataset for training becomes 0, and \tilde{Σ}ₗ⁻¹ denotes a singular value obtained by the singular value decomposition calculation, and the variables are collected during extraction of the hierarchical information of the trained autoencoder.

In the calculating of the anomaly scores, the anomaly score of the output value of each of the L hidden layers included in the encoder for the network data may be calculated by using an equation which is ∈ₘ(x)=Σₗ₌₀^{m-2}L_{NL1}(dₗ)=Σₗ₌₀^{m-2}∥(dₗ−μₗ^{T})^{T}Vₗ\tilde{Σ}ₗ⁻¹∥₁ where, m is a value greater than or equal to 3, dₗ is a reconstruction error corresponding to an error value between an output value output from the l-th hidden layer when network data is input to an encoder and an output value output from the l-th hidden layer when reconstruction data is input to the encoder, and μₗ^{T} is an average of reconstruction errors of the l-th hidden layer for normal dataset for training.

In determining whether the intrusion is detected, when the anomaly scores of the latent vector, the reconstruction data, and the network data in each of the L hidden layers included in the encoder are greater than the threshold value for the normal data for training, the network data may be detected as abnormal data, when the anomaly score of the network data in the latent vector is less than or equal to the threshold value set through the latent vector, moving to the decoder may be performed, when the anomaly score of the network data in the reconstruction data is higher than the threshold value set through the reconstruction data, moving to the l-th hidden layer included in the encoder may be performed, when the anomaly score of the network data in l-th hidden layer is less than or equal to the threshold value in the l-th hidden layer, moving to l+1-th hidden layer included in the encoder may be performed, and the anomaly scores may be compared with the threshold value for each of the L hidden layers included in the encoder to sequentially determine whether an intrusion into the network data is detected.

In determining whether the intrusion is detected, the network data may be determined as normal only when the anomaly score of the network data in the last L-th hidden layer among the L hidden layers included in the encoder is less than or equal to the threshold value in the last L-th hidden layer.

According to another aspect of the present disclosure, a hierarchical network intrusion detection system based on hidden layer information of an autoencoder includes a preprocessor configured to normalize and preprocess normal data for training in a state in which the normal data for training is collected, a training unit configured to output reconstruction data by inputting the preprocessed normal data for training into the autoencoder including an encoder and a decoder, calculate a reconstruction error by using the preprocessed normal data for training and the reconstruction data, and train the autoencoder to minimize a reconstruction error value, a setting unit configured to extracting hierarchical information of the trained autoencoder and set a threshold value for the normal data for training by using latent vector for the normal data for training, the reconstruction data, and an output value of each of L hidden layers included in the encoder, a calculation unit configured to calculate anomaly scores of the latent vector for the network data, the reconstruction data, and an output value of each of the L hidden layers included in the encoder in a state in which a target network data is input to the autoencoder, and a control unit configured to determine whether an intrusion into the network data is detected by using the threshold value and the anomaly scores.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a configuration of a hierarchical network intrusion detection system based on hidden layer information of an autoencoder, according to an embodiment of the present disclosure;

FIG. 2 is a flowchart illustrating a process of training an autoencoder, according to an embodiment of the present disclosure;

FIG. 3 illustrates a standard scaler method;

FIG. 4 is a table illustrating step S240 of FIG. 2;

FIG. 5 is a flowchart illustrating a hierarchical network intrusion detection method using a hierarchical network intrusion detection system based on hidden layer information of an autoencoder, according to an embodiment of the present disclosure;

FIGS. 6A to 6E are tables illustrating network data;

FIG. 7A is a diagram illustrating a first stage of the hierarchical network intrusion detection method according to the embodiment of the present disclosure;

FIG. 7B is a diagram illustrating a second stage of the hierarchical network intrusion detection method according to the embodiment of the present disclosure;

FIG. 7C is a diagram illustrating stage 3 to stage L+2 of the hierarchical network intrusion detection method according to the embodiment of the present disclosure; and

FIGS. 8A to 8D illustrate hierarchical network intrusion detection performances.

### DETAILED DESCRIPTION

Hereinafter, embodiments of the present disclosure will be described in detail with reference to the accompanying drawings such that those skilled in the art may easily implement the embodiments. However, the present disclosure may be embodied in several different forms and is not limited to the embodiments described herein. In order to clearly describe the present disclosure in the drawings, parts irrelevant to the description are omitted, and similar reference numerals are attached to similar components throughout the specification.

Throughout the specification, when a unit “includes” a certain component, this means that other components may be further included, rather than excluding the other components, unless otherwise stated.

Then, embodiments of the present disclosure will be described in detail with reference to the accompanying drawings such that those skilled in the art to which the present disclosure pertains may easily implement the embodiments.

Hereinafter, a configuration of a hierarchical network intrusion detection system 100 based on hidden layer information of an autoencoder, according to an embodiment of the present disclosure will be described with reference to FIG. 1.

FIG. 1 is a diagram illustrating the configuration of the hierarchical network intrusion detection system based on the hidden layer information of the autoencoder according to the embodiment of the present disclosure.

As illustrated in FIG. 1, the hierarchical network intrusion detection system 100 based on the hidden layer information of the autoencoder, according to the embodiment of the present disclosure includes a preprocessing unit 110, a training unit 120, a setting unit 130, a calculation unit 140, and a control unit 150.

First, the preprocessing unit 110 performs preprocessing by normalizing normal data for training.

In this case, the normal data for training includes only normal data for training an autoencoder and consists of multiple dimensions, and each dimension is distributed in various ranges.

Accordingly, the preprocessing unit 110 performs preprocessing for uniformly matching a range of dimensions for the normal data for training composed of multiple dimensions.

Next, the training unit 120 inputs the preprocessed normal data for training to an autoencoder including an encoder and a decoder to output reconstruction data, and calculates a reconstruction error by using the preprocessed normal data for training and the reconstruction data.

Then, the training unit 120 trains the autoencoder such that the reconstruction error is minimized.

In this case, the training unit 120 trains an encoder to input the preprocessed normal data for training to the encoder to output latent vector and trains a decoder to input the latent vector to the decoder to output the reconstruction data.

Then, the training unit 120 trains the autoencoder such that the reconstruction error value is minimized by calculating a reconstruction error by using preprocessed normal data for training for a training process, reconstruction data of the decoder for the preprocessed normal data for training, and a mean squared error (MSE) loss function.

Next, the setting unit 130 extracts hierarchical information of the autoencoder for which training has been completed.

Then, the setting unit 130 sets a threshold value by using the latent vector for the normal data for training, the reconstruction data, and an output value for each of L hidden layers included in the encoder.

In this case, the threshold value may be set based on anomaly scores of the latent vector for the normal data for training, the reconstruction data, and the output values for the respective hidden layers.

Then, the setting unit 130 sets the threshold value to minimize a fall-out rate for the normal data for each of the other hidden layers except for the last L-th hidden layer among the L hidden layers included in the encoder and sets the threshold value to maximize a detection rate of abnormal data of the last L-th hidden layer.

Next, the calculation unit 140 calculates anomaly scores of the latent vector, the reconstruction data, and the output value for each of the L hidden layers included in the encoder in a state in which target network data is input to the autoencoder.

In this case, the calculation unit 140 calculates an anomaly score of the latent vector for network data by using the Mahalanobis distance.

Then, the calculation unit 140 calculates anomaly scores of the reconstruction data of the network data and the output value for each of the L hidden layers included in the encoder by using a normalized L1-norm method which is a distance measurement method.

Next, the control unit 150 determines whether an intrusion into the network data is detected by using a preset threshold value and the calculated anomaly score.

In this case, the control unit 150 detects the network data as abnormal data when anomaly scores for the latent vector, the reconstruction data, and the network data in each of the L hidden layers included in the encoder are greater than a threshold value set by using the latent vector for training data, the reconstruction data, and the output value for each of the L hidden layers included in the encoder.

Meanwhile, the control unit 150 moves to the decoder when the anomaly score for the network data of the latent vector is less than or equal to the threshold value for the normal data for training set in the latent vector.

Then, the control unit 150 moves to the l-th hidden layer included in the encoder when the anomaly score for the network data of the reconstruction data is less than or equal to the threshold value for the normal data for training set in the reconstruction data.

In addition, when the anomaly score for the network data in the l-th hidden layer is less than or equal to the threshold value for the normal data for training set in the l-th hidden layer, the control unit 150 moves to the l+1-th hidden layer included in the encoder and compares the anomaly score for each of the L hidden layers with the threshold value to gradually determine whether an intrusion into the network data is detected.

In this case, the control unit 150 may determine the network data as normal data only when the anomaly score for the network data in the last L-th hidden layer among the L hidden layers is less than or equal to the threshold value for the normal data for training set in the last L-th hidden layer.

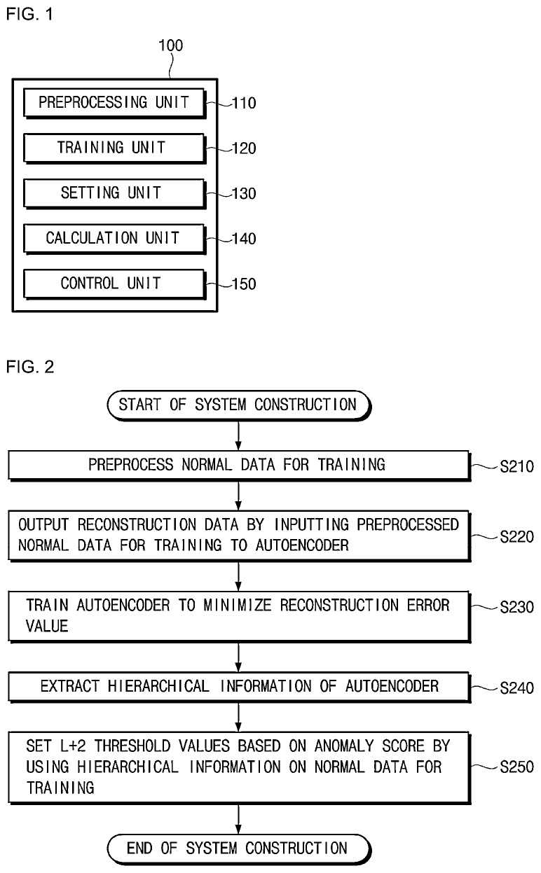

Hereinafter, a process of training an autoencoder according to an embodiment of the present disclosure will be described with reference to FIGS. 2 to 4.

FIG. 2 is a flowchart illustrating a process of training an autoencoder according to an embodiment of the present disclosure.

First, the hierarchical network intrusion detection system 100 according to an embodiment of the present disclosure performs preprocessing by normalizing normal data for training in a state in which the normal data for training is collected (S210).

In this case, the hierarchical network intrusion detection system 100 may collect only normal data for training in order to train an autoencoder including an encoder and a decoder.

Then, the hierarchical network intrusion detection system 100 performs preprocessing by normalizing the normal data for training by using an average of the previously collected normal data for training and a standard deviation.

In this case, the hierarchical network intrusion detection system 100 may use a standard scaler method and a min-max scaler method as a preprocessing method.

Here, the standard scaler method may represent a method of constantly changing units of data feature values through data normalization by using an average of the data feature values and a standard deviation.

For example, the hierarchical network intrusion detection system 100 according to an embodiment of the present disclosure may set all data feature values of original data to have the same scale and an average to 0 and change the standard deviation to 1.

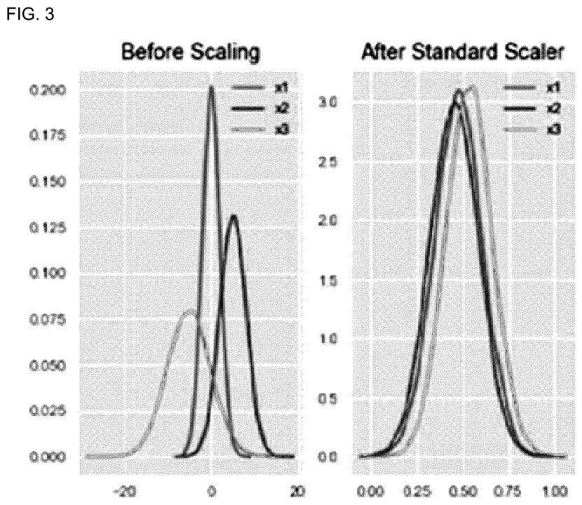

FIG. 3 illustrates the standard scaler method.

As illustrated in FIG. 3, when the hierarchical network intrusion detection system 100 performs preprocessing by using the standard scaler method, data may be distributed to an average of 0 and a standard deviation of 1.

In this case, the hierarchical network intrusion detection system 100 may perform preprocessing of normal data for training through the standard scaler method by using Equation 1 below.

$${\tilde{x}}_{n m} = \frac{{x}_{nm} - {μ}_{m}}{{σ}_{m}} , {μ}_{m} = \frac{{\sum }_{n = 1}^{N} {x}_{n m}}{N} , \qquad Equation 1$$

$${σ}_{m} = \frac{{\sum }_{n = 1}^{N} {( {x}_{n m} - {μ}_{m} )}^{2}}{N} \begin{matrix}n = 1 , 2 , … , N \\ m = 1 , 2 , … , M\end{matrix}$$

Here, x is normal data for training, \tilde{x} is preprocessed normal data for training, μₘ is an average of the feature values of the normal data for training, σₘ is the standard deviation of the feature values of the normal data for training, N is the total sample number of the normal data for training, n is a sample index of the normal data for training, M is the total feature value number of normal data for training, and m represents feature value index for the normal data for training.

In addition, the hierarchical network intrusion detection system 100 may perform preprocessing by using not only the standard scaler method but also the min-max scaler method and perform preprocessing of the normal data for training by using Equation 2 below.

$${\tilde{x}}_{n m} = \frac{{x}_{n m} - {min}_{m}}{{max}_{m} - {min}_{m}} , \begin{matrix}n = 1 , 2 , … , N \\ m = 1 , 2 , … , M\end{matrix} \qquad Equation 2$$

Here, the hierarchical network intrusion detection system 100 performs preprocessing for the previously collected normal data for training and preprocessing for the network data collected when the actual system operates in the same manner as each other.

Next, the hierarchical network intrusion detection system 100 according to an embodiment of the present disclosure inputs the preprocessed normal data for training to the autoencoder to output reconstruction data (S220).

In this case, the autoencoder may include an encoder that reduces a dimension of the normal data for training and a decoder that reconstructs a dimension of the reduced normal data for training.

More specifically, the hierarchical network intrusion detection system 100 inputs the preprocessed normal data for training to the encoder to output latent vector.

In this case, the encoder outputs latent vector obtained by reducing the normal data for training into a low-dimensional latent space having only meaningful information.

In addition, the hierarchical network intrusion detection system 100 inputs the latent vector to the decoder to output reconstruction data.

Here, the decoder reconstructs the normal data for training to a dimension before the latent space with a reduced dimension is input to be reduced, and outputs the reconstructed the normal data for training.

In addition, the hierarchical network intrusion detection system 100 according to an embodiment of the present disclosure calculates a reconstruction error by using the preprocessed normal data for training and the reconstruction data.

In this case, the hierarchical network intrusion detection system 100 calculates the reconstruction error by using the preprocessed normal data for training for a training process, the reconstruction data of the decoder for the preprocessed normal data for training, and an MSE loss function and by using Equation 3 below.

$$J ( {X}_{nor} , {\hat{X}}_{nor} ) = \frac{1}{N} {\sum }_{n = 1}^{N} {( {x}_{nor , n} - {\hat{x}}_{nor , n} )}^{2} \qquad Equation 3$$

where, J is a loss function, Xₙₒᵣ is preprocessed normal data set for training, \tilde{X}ₙₒᵣ is the reconstruction data for a preprocessed normal dataset for training, N is the number of data samples of the normal dataset for training, x_{nor,n} is an N-th sample of Xₙₒᵣ, and \hat{x}_{nor,n} is an N-th sample of \tilde{X}ₙₒᵣ.

Next, the hierarchical network intrusion detection system 100 according to an embodiment of the present disclosure trains an autoencoder such that a reconstruction error value is minimized (S230).

More specifically, the hierarchical network intrusion detection system 100 trains the encoder by setting the preprocessed normal data for training as input data of the encoder and setting latent vector as output data of the encoder.

In addition, the hierarchical network intrusion detection system 100 trains the decoder by setting the latent vector as input data of the decoder and setting the reconstruction data as output data of the decoder.

Next, the hierarchical network intrusion detection system 100 trains the autoencoder such that a reconstruction error value is minimized by using error values between the preprocessed normal data for training and the reconstruction data.

That is, the hierarchical network intrusion detection system 100 recognizes pattern information of normal data through training of the autoencoder.

Then, data having a pattern of normal data has a small reconstruction error, and data having a pattern different from the pattern of the normal data has a large reconstruction error.

Next, the hierarchical network intrusion detection system 100 according to an embodiment of the present disclosure extracts learned hierarchical information of the autoencoder (S240).

For example, the hierarchical network intrusion detection system 100 may extract hierarchical information including an input dataset, a reconstruction dataset, the number of hidden layers of an encoder and a decoder, latent vector of an encoder for input data, output values of L hidden layers included in an encoder for input data, a reconstruction error of each of L hidden layers of an encoder for input data, and a reconstruction error of each of L hidden layers included in an encoder for normal data for training.

In this case, the encoder and the decoder each include L hidden layers.

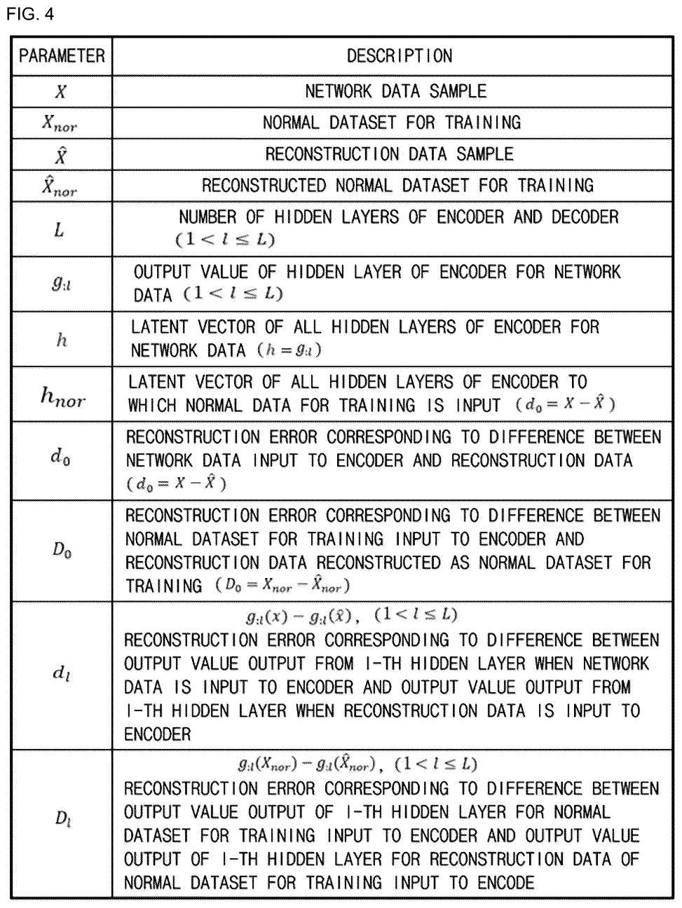

FIG. 4 is a table illustrating step S240 of FIG. 2.

As illustrated in FIG. 4, X is a network data sample, Xₙₒᵣ is a normal dataset for training, \hat{X} is a reconstruction data sample, \hat{X}ₙₒᵣ is a reconstructed normal data set for training, L is the number of hidden layers of each of an encoder and a decoder, g_{:l} is an output value of a hidden layer of an encoder for the network data, h is latent vector of all hidden layers of an encoder for the network data, hₙₒᵣ is latent vector of all hidden layers of an encoder to which normal data for training is input, do is a reconstruction error corresponding to an error value between the network data input to an encoder and reconstruction data, di is a reconstruction error corresponding to an error value between an output value of the l-th hidden layer for network data input to the encoder and an output value of the l-th hidden layer for reconstruction data input to the encoder, D₀ is a reconstruction error corresponding to an error value between normal dataset for training input to an encoder and reconstruction data reconstructed as the normal dataset for training, and Dₗ is a reconstruction error corresponding to an error value between an output value of the l-th hidden layer for the normal dataset for training input to an encoder and an output value of the l-th hidden layer for the reconstruction data reconstructed as the normal dataset for training input to the encoder.

In addition, the hierarchical network intrusion detection system 100 sets a threshold value for anomaly detection by using hierarchical information and by using latent vector for normal data for training, reconstruction data, and an output value of each of L hidden layers included in an encoder (S250).

In this case, the encoder includes the L hidden layers, and thus, the hierarchical network intrusion detection system 100 may set L+2 threshold values by using the latent vector for the normal data for training, the reconstruction data, and the output value of each of the L hidden layers included in the encoder.

That is, the hierarchical network intrusion detection system 100 sets L+2 threshold values based on an anomaly score by using hierarchical information on normal data for training.

In more detail, the hierarchical network intrusion detection system 100 sets the threshold values based on anomaly scores of the latent vector for the normal data for training, the reconstruction data, and the output value of each hidden layer.

Then, the hierarchical network intrusion detection system 100 sets threshold values to minimize a fall-out rate for normal data for each of the remaining hidden layers except for the last L-th hidden layer among the L hidden layers, and sets the threshold values to maximize a detection rate (recall) of abnormal data of the last L hidden layer.

For example, the hierarchical network intrusion detection system 100 sets latent vector as the first stage, reconstruction data as the second stage, and an output value for each of a plurality of hidden layers included in an encoder as the m-th stage.

In addition, m is a value greater than or equal to 3, and the hierarchical network intrusion detection system 100 may set the first hidden layer among the plurality of hidden layers included in the encoder as the third stage, the second hidden layer as the fourth stage, and the l-th hidden layer as the l+2-th stage.

That is, the hierarchical network intrusion detection system 100 may set a threshold value for normal data for training in the latent vector to δ₁, a threshold value for normal data for training in reconstruction data to δ₂, and a threshold value for normal data for training in an output value of each of L hidden layers included in an encoder to δₘ.

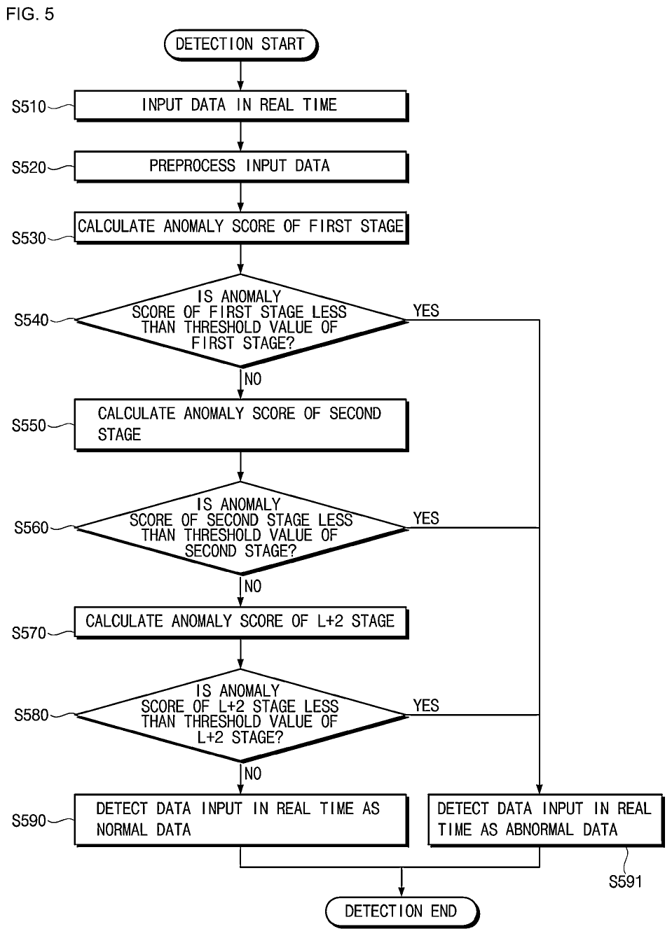

Hereinafter, a method of hierarchically detecting an intrusion into a network using a hierarchical network intrusion detection system based on hidden layer information of an autoencoder, according to an embodiment of the present disclosure will be described with reference to FIGS. 5 to 8D.

FIG. 5 is a flowchart illustrating a hierarchical network intrusion detection method using a hierarchical network intrusion detection system based on hidden layer information of an autoencoder, according to an embodiment of the present disclosure.

First, the hierarchical network intrusion detection system 100 according to the embodiment of the present disclosure inputs target network data to an autoencoder (S510).

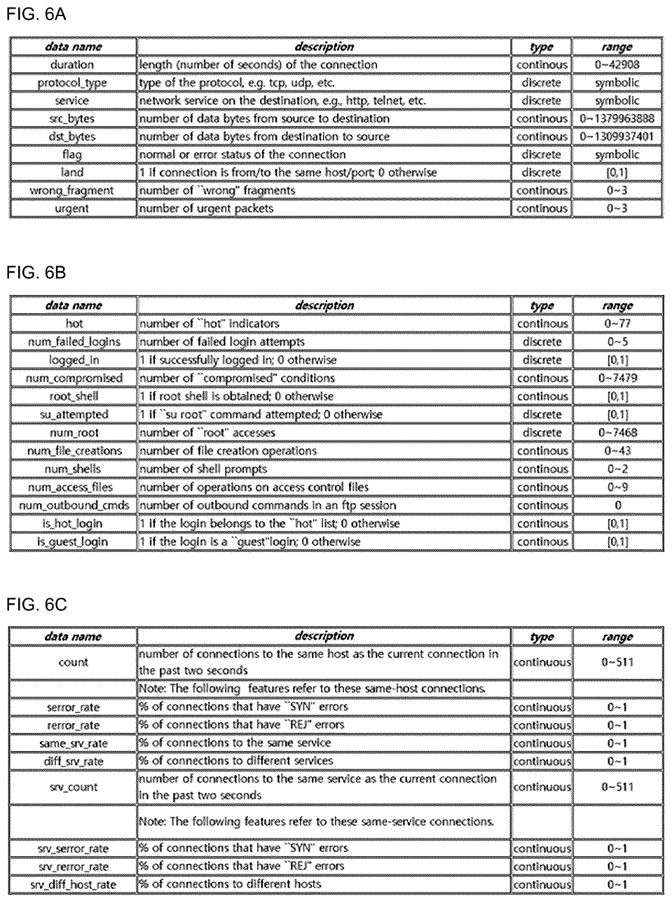

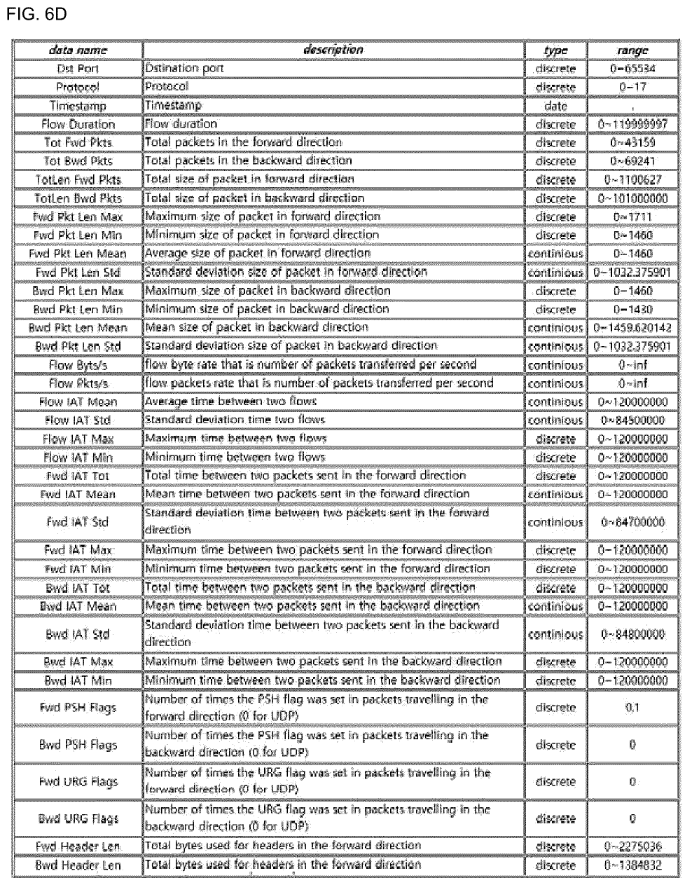

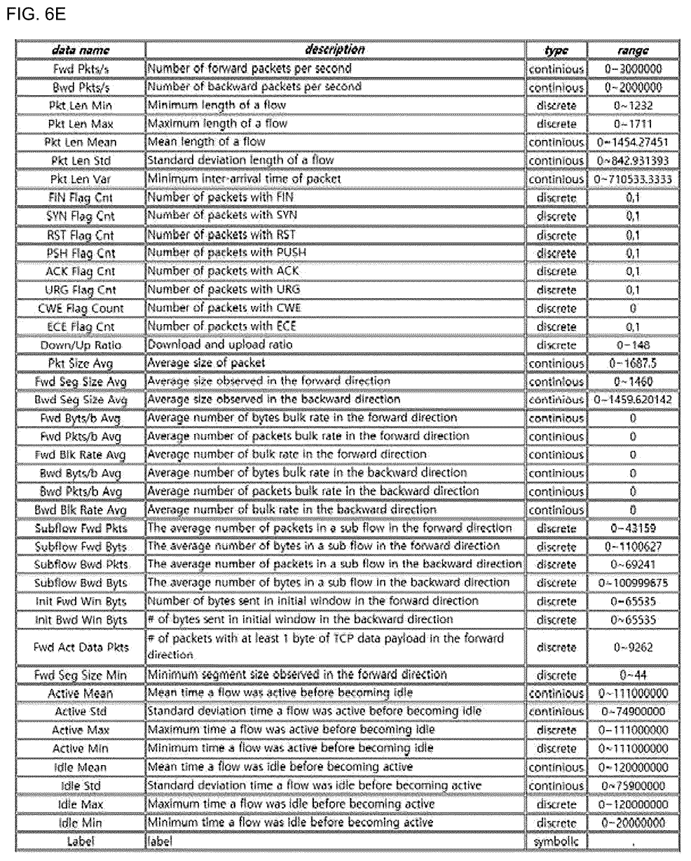

FIGS. 6A to 6E are tables illustrating network data.

FIGS. 6A to 6C are tables illustrating feature information of an NSL-KDD dataset, and FIGS. 6D and 6E are tables illustrating feature information of a CSE-CIC-IDS 2018 dataset.

More specifically, FIG. 6A illustrates network data representing basic feature information of an individual TCP connection, and the network data may include duration, protocol_type, service, src_bytes, dst_bytes, flag, land, wrong, fragment, and urgent.

In addition, FIG. 6B illustrates network data representing content feature information in a connection suggested by knowledge of a specific field, and the network data may include hot, num_failed_logins, logged_in, num_compromised, root_shell, su_attempted, num_root, num_file_creations, num_shells, num_access_files, num_outbound_cmds, is_hot_login, and is_guest_login.

In addition, FIG. 6C illustrates network data representing traffic feature information calculated by using a 2-second time window, and the network data may include count, serror_rate, rerror_rate, same_srv_rate, diff_srv_rate, srv_count, srv_serror_rate, srv_rerror_rate, and srv_diff host_rate.

In addition, as illustrated in FIGS. 6D and 6E, feature information of the CSE-CIC-IDS 2018 dataset may include Dst Port, Protocol, Timestamp, Flow Duration, Tot Fwd Pkts, Tot Bwd Pkts, TotLen Fwd Pkts, TotLen Bwd Pkts, Fwd Pkt Len Max, Fwd Pkt Len Min, Fwd Pkt Len Mean, Fwd Pkt Len Std, Bwd Pkt Len Max, Bwd Pkt Len Min, Bwd Pkt Len Mean, Bwd Pkt Len Std, Flow Bytes/s, Flow Pkt, Flow IAT Mean, Flow IAT Std, Flow IAT Max, Flow IAT Min, Fwd IAT Tot, Fwd IAT Mean, Fwd IAT Std, Fwd IAT Max, Fwd IAT Min, Bwd IAT Tot, Bwd IAT Mean, Bwd IAT Std, Bwd IAT Max, Bwd IAT Min, Fwd PSH Flags, Bwd PSH Flags, Fwd URG Flags, Bwd URG Flags, Fwd Header Len, Bwd Header Len, Fwd Pkts/s, Bwd Pkts/s, Pkt Len Min, Pkt Len Max, Pkt Len Mean, Pkt Len Std, Pkt Len Var, FIN Flag Cnt, SYN Flag Cnt, RST Flag Cnt, PSH Flag Cnt, ACK Flag Cnt, URG Flag Cnt, CWE Flag Count, ECE Flag Cnt, Down/Up Ratio, Pkt Size Avg, Fwd Seg Size Avg, Bwd Seg Size Avg, Fwd Bytes/b Avg, Fwd Pkts/b Avg, Fwd Blk Rate Avg, Bwd Bytes/b Avg, Bwd Pkts/b Avg, Bwd Blk Rate Avg, Subflow Fwd Pkts, Subflow Fwd Bytes, Subflow Bwd Pkts, Subflow Bwd Bytes, Init Fwd Win Bytes, Init Bwd Win Bytes, Fwd Act Data Pkts, Fwd Seg Size Min, Active Mean, Active Std, Active Max, Active Min, Idle Mean, Idle Std, Idle Max, Idle Min, and Label.

Next, the hierarchical network intrusion detection system 100 according to the embodiment of the present disclosure normalizes network data to perform preprocessing (S520).

In this case, since step S520 is previously described in step S210 of FIG. 2, detailed descriptions thereof are omitted.

Next, the hierarchical network intrusion detection system 100 according to the embodiment of the present disclosure calculates anomaly scores of latent vector for network data, reconstruction data, and an output value of each of L hidden layers included in an encoder (S530).

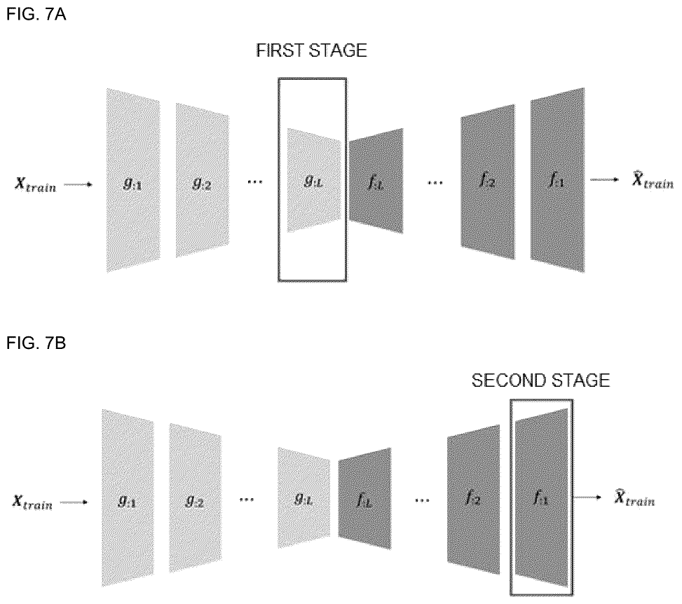

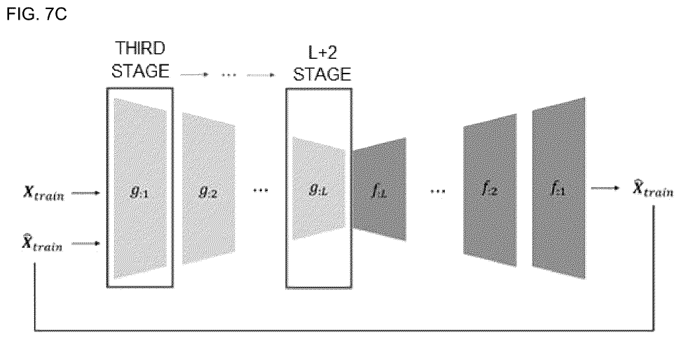

Hereinafter, step S530 of FIG. 5 will be described with reference to FIGS. 7A to 7C.

FIG. 7A is a diagram illustrating the first stage of the hierarchical network intrusion detection method according to the embodiment of the present disclosure.

As illustrated in FIG. 7A, in the first stage, the hierarchical network intrusion detection system 100 according to the embodiment of the present disclosure calculates an anomaly score of latent vector for network data through Equation 4 below by using an output value of an encoder output from the network data input to an encoder.

In this case, the hierarchical network intrusion detection system 100 may calculate an anomaly score by using a Mahalanobis distance.

∈₁(x)= [symbol] _{MD}=\sqrt{(h−μₙₒᵣ)^{T}Σₙₒᵣ⁻¹(h−μₙₒᵣ)} Equation 4
where ∈ is an anomaly score of randomly input network data, [symbol] _{MD} is a measurement value of Mahalanobis distance (MD), h is latent vector of an encoder for network data, μₙₒᵣ is an average of latent vector of an encoder to which normal data for md training is input, Σₙₒᵣ is a latent vector covariance of normal data for training, and T denotes a transpose matrix.

Next, the hierarchical network intrusion detection system 100 according to the embodiment of the present disclosure determines whether the anomaly score of the first stage is less than the threshold value of the first stage (S540).

When the anomaly score of the first stage is greater than the threshold value of the first stage, the hierarchical network intrusion detection system 100 detects data input in real time as abnormal data (S591).

In contrast to this, when the anomaly score of the first stage is less than the threshold value of the first stage, the hierarchical network intrusion detection system 100 proceeds to the next stage.

FIG. 7B is a diagram illustrating the second stage of the hierarchical network intrusion detection method according to the embodiment of the present disclosure.

As illustrated in FIG. 7B, in the second stage, the hierarchical network intrusion detection system 100 according to the embodiment of the present disclosure calculates a reconstruction error used to calculate an anomaly score with a reconstruction data of network data by using Equation 5 below.

The reconstruction error used to calculate the anomaly score is calculated by Equation 5 below.

$${d}_{l} = \{ \begin{matrix}x - \hat{x} & ( l = 0 ) \\ {g}_{: l} ( x ) - {g}_{: l} ( \hat{x} ) & ( 0 < l \leq L )\end{matrix} \qquad Equation 5$$

where dₗ is a reconstruction error used for calculating an anomaly score, l denotes a position at which the reconstruction error is obtained and denotes an output part of a decoder when l=0 and denotes l-th hidden layer part of the encoder when 0<l≤L, x is a preprocessed input data sample, \hat{x} is reconstruction data for x, and g_{:l} denotes calculation up to the l-th hidden layer.

In a step of calculating the anomaly score, a variable for calculating the anomaly score for the network data may be calculated by using the following equation.

In addition, the hierarchical network intrusion detection system 100 calculates a variable for calculating an anomaly score of network data by using Equation 6 below.

D₀=Xₙₒᵣ−\hat{X}ₙₒᵣ

μ₀= [symbol] (D₀)

D̅₀=D₀− [symbol] _{N×1}×μ₀

D̅₀=U₀\tilde{Σ}₀V₀⁻¹ Equation 6

where, μ₀^{T} is an average of reconstruction errors corresponding to error values between the input data for normal dataset for training and reconstruction data, V₀ is a right singular vector obtained by performing a singular value decomposition calculation of D̅₀ that is linearly shifted such that an average of a reconstruction error D₀ of a normal dataset for training and a reconstruction dataset of the normal dataset for training becomes 0, and \tilde{Σ}₀⁻¹ denotes a singular value obtained by the singular value decomposition calculation.

In this case, variables are collected in the process of extracting hierarchical information of a trained autoencoder.

Then, the hierarchical network intrusion detection system 100 according to the embodiment of the present disclosure calculates an anomaly score of an output value of a decoder for network data by using Equation 7 below (S550).

In this case, the hierarchical network intrusion detection system 100 may calculate the anomaly score by using a normalized L1-norm method.

∈₂(x)=L_{NL1}(d₀)=∥(d₀−μ₀^{T})^{T}V₀\tilde{Σ}₀⁻¹∥₁ Equation 7
where, [symbol] _{NL1} is a value measured by the normalized L1-norm method, d₀ is reconstruction errors corresponding to error values between network data and reconstruction data of the network data, and μ₀^{T} is an average of reconstruction errors corresponding to error values of input data of the normal dataset for training and reconstruction data.

In this case, the hierarchical network intrusion detection system 100 according to the embodiment of the present disclosure determines whether the anomaly score of the second stage is less than the threshold value of the second stage (S560).

When the anomaly score of the second stage is greater than the threshold value of the second stage, the hierarchical network intrusion detection system 100 detects data input in real time as abnormal data (S591).

In addition, the anomaly score of the second stage is less than the threshold value of the second stage, the hierarchical network intrusion detection system 100 proceeds to the next stage.

FIG. 7C is a diagram illustrating stage 3 to stage L+2 of the hierarchical network intrusion detection method according to the embodiment of the present disclosure.

As illustrated in FIG. 7C, the hierarchical network intrusion detection system 100 according to the embodiment of the present disclosure inputs reconstruction data to an encoder.

In addition, the hierarchical network intrusion detection system 100 according to the embodiment of the present disclosure outputs an output value of each hidden layer from the reconstruction data through the L hidden layers included in the encoder.

In addition, the hierarchical network intrusion detection system 100 calculates variables for calculating an anomaly score of network data by using Equation 8 below.

Dₗ=g_{:l}(Xₙₒᵣ)−g_{:l}(\hat{X}ₙₒᵣ)

μₗ= [symbol] (Dₗ)

D̅ₗ=Dₗ− [symbol] _{N×1}×μₗ

D̅ₗ=Uₗ\tilde{Σ}ₗVₗ⁻¹ Equation 8
where, μₗ^{T} is an average of reconstruction errors of the l-th hidden layer for a normal dataset for training, Vₗ a right singular vector obtained by performing a singular value decomposition calculation of D̅ₗ that is linearly shifted such that an average of reconstruction errors Dₗ of the l-th hidden layer of a normal dataset for training becomes 0, and \tilde{Σ}ₗ⁻¹ denotes a singular value obtained by the singular value decomposition calculation.

In this case, the variables are collected in the process of extracting hierarchical information of a trained autoencoder.

Then, the hierarchical network intrusion detection system 100 according to the embodiment of the present disclosure calculates an anomaly score of an output value of each of L hidden layers included in an encoder for network data by using Equation 9 below (S570)).

∈ₘ(x)=Σₗ₌₀^{m-2}L_{NL1}(dₗ)=Σₗ₌₀^{m-2}∥(dₗ−μₗ^{T})^{T}Vₗ\tilde{Σ}ₗ⁻¹∥₁ Equation 9
where, m is a value greater than or equal to 3, dₗ is a reconstruction error corresponding to an error value between an output value output from the l-th hidden layer when network data is input to an encoder and an output value output from the l-th hidden layer when reconstruction data is input to the encoder, and μₗ^{T} is an average of reconstruction errors of the l-th hidden layer for normal dataset for training.

In this case, l denotes an index of the hidden layer.

That is, since detection of an intrusion into the first hidden layer among L hidden layers included in an encoder is set as the third stage, the hierarchical network intrusion detection system 100 substitutes 3 for m and calculates an anomaly score of an output value of the first hidden layer by using Equation 9, and since an intrusion detection process for the L-th hidden layer is set to the L+2-th stage, the hierarchical network intrusion detection system 100 substitutes L+2 form and calculates an anomaly score of an output value of the l-th hidden layer by using Equation 4.

In this case, the hierarchical network intrusion detection system 100 according to the embodiment of the present disclosure determines whether the anomaly score of the L+2-th stage is less than the threshold value of the L+2-th stage (S580).

When the anomaly score of the L+2-th stage is greater than the threshold value of the L+2-th stage, the hierarchical network intrusion detection system 100 detects data input in real time as abnormal data (S591).

In addition, when the anomaly score of the L+2-th stage is less than the threshold value of the L+2-th stage, the hierarchical network intrusion detection system 100 according to the embodiment of the present disclosure detects the data input in real time as normal data (S390).

In more detail, when anomaly scores of latent vector for network data, reconstruction data, and an output value of each of L hidden layers are greater than threshold values of latent vector for normal data for training, the reconstruction data, and the output value of each of the L hidden layers, the hierarchical network intrusion detection system 100 detects the corresponding network data as abnormal data.

In addition, when the anomaly score of the latent vector for network data is less than or equal to the threshold value set by using the latent vector for normal data for training, the hierarchical network intrusion detection system 100 inputs the latent vector for the network data to the decoder.

Then, when an anomaly score of the reconstruction data for the network data is less than or equal to a threshold value set by using the reconstruction data for the normal data for training, the hierarchical network intrusion detection system 100 inputs the reconstruction data for the network data to the encoder.

Then, the reconstruction data for the network data is input to the first hidden layer included in the encoder, and when an anomaly score of the output value of the first hidden layer for the network data is less than or equal to a threshold value set by using the output value of the first hidden layer for the normal data for training, the hierarchical network intrusion detection system 100 inputs the output value of the first hidden layer to the second hidden layer.

For example, when an anomaly score of an output value of the second hidden layer for the network data is greater than a threshold set by using the output value of the second hidden layer for the normal data for training, the hierarchical network intrusion detection system 100 may detect the network data as abnormal data.

When the anomaly score of the output value of the second hidden layer for the network data is less than or equal to the threshold value set by using the output value of the second hidden layer for the normal data for training, the hierarchical network intrusion detection system 100 inputs the output value of the second hidden layer to the third hidden layer.

In this way, the hierarchical network intrusion detection system 100 according to the embodiment of the present disclosure performs detection in each stage from the first stage to the L+2-th stage, and when the network data is not abnormally detected, the hierarchical network intrusion detection system 100 performs detection in the next stage.

In addition, only when an anomaly score of an output value of the last L-th hidden layer for the network data is less than or equal to a threshold value set by using an output value of the last L-th hidden layer for the normal data for training, the network is detected as normal.

That is, the hierarchical network intrusion detection system 100 according to the embodiment of the present disclosure compares anomaly scores with threshold values for each hidden layer from the first hidden layer to the last L-th hidden layer to detect whether the corresponding network data is abnormal data.

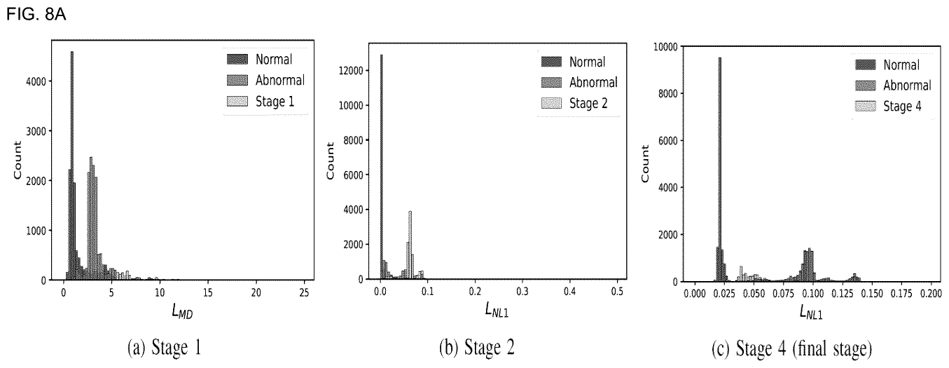

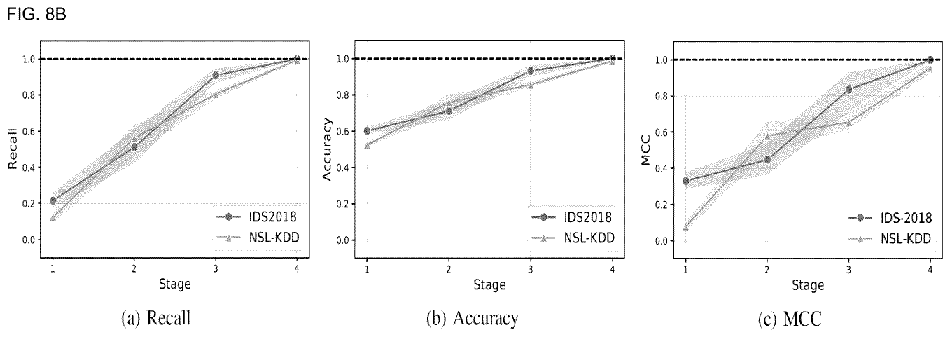

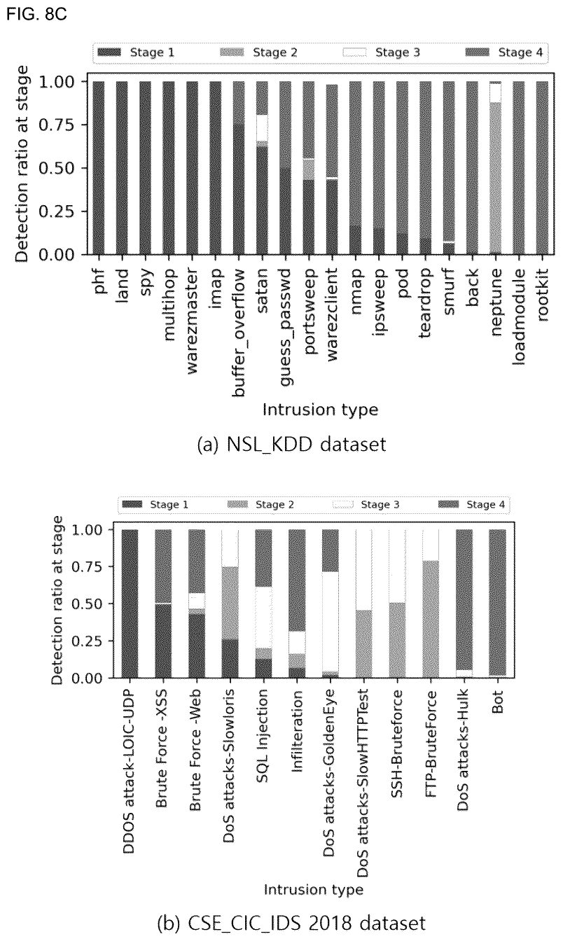

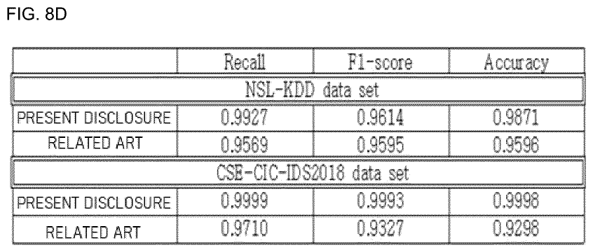

Hereinafter, a result of comparing the embodiment of the related art with the embodiment of the present disclosure with reference to FIGS. 8A to 8D will be described.

First, FIGS. 8A to 8C are graphs illustrating hierarchical network intrusion detection performances.

FIG. 8A illustrates histograms of normal data and abnormal data for anomaly scores, and FIG. 8B illustrates an accumulation detection rate of the abnormal data according to hierarchical stages.

FIG. 8C illustrates a ratio between abnormal types detected for each stage, and FIG. 7D is a table illustrating experimental results obtained by comparing detection performance of the related art and detection performance of the present disclosure.

As illustrated in FIG. 8A, since normal data overlaps abnormal data at an output (stage 1, the first stage) of an encoder, the hierarchical network intrusion detection system 100 detects only a clear abnormal value.

In this case, the hierarchical network intrusion detection system 100 according to the embodiment of the present disclosure may first detect abnormal data having an extreme abnormal value in the output (first stage) of the encoder.

In addition, the hierarchical network intrusion detection system 100 according to the embodiment of the present disclosure detects about half of the abnormal data in an output (stage 2, the second stage) of a decoder and successfully detects 99.27% of the abnormal data in the last stage (stage 4, the fourth stage) which is an output of a re-examined encoder, and thus, a false detection rate is reduced at which normal data is falsely detected as abnormal data.

An experiment was performed for hierarchical anomaly detection using two types of network data, and performance curves for each stage are illustrated in FIG. 8 by using three performance indicators including a recall rate, accuracy, and Matthews correlation coefficients (MCCs).

In this case, according to the hierarchical network intrusion detection system 100 of the embodiment of the present disclosure, it can be seen that performance increases in all performance indicators as a stage increases and approaches 1.0 in the final stage.

(a) of FIG. 8B (a) illustrates a ratio (recall) accurately predicted as abnormal among the abnormal data, and the recall rate approaches 1.0 as the stages progress.

That is, the hierarchical network intrusion detection system 100 according to the embodiment of the present disclosure detects anomalies of approximately 100%.

(b) and (c) of FIG. 8B respectively illustrate accuracy and MCC accurately predicted in the total input data including normal data and abnormal data.

Here, the MCC is an indicator representing a correlation between a predicted data class and an actual data class, where a coefficient of +1 indicates a perfect prediction, 0 indicates worse than a random prediction, and −1 indicates an overall discrepancy between the predicted data class and the actual data class.

As illustrated in (b) and (c) of FIG. 8B, as the stage increases, the accuracy and the MCC increase, and the hierarchical network intrusion detection system 100 approaches +1 in the final stage (fourth stage).

That is, the hierarchical network intrusion detection system 100 according to the embodiment of the present disclosure may differentiate a detection time through the hierarchical anomaly detection and may quickly detect abnormal data having a large abnormal value.

FIG. 8C illustrates visualization of a detection rate of each stage for all intrusion types.

As illustrated in FIG. 8C, the hierarchical network intrusion detection system 100 according to the embodiment of the present disclosure may perform anomaly detection in response to stages of data detected through role division depending on abnormality types in each stage.

In this case, the hierarchical network intrusion detection system 100 may have different types of abnormal data detected at each stage.

For example, as illustrated in FIG. 8C, in each graph, the abnormal data detected in the first stage is displayed in blue, the abnormal data detected in the second stage is displayed in orange, the abnormal data detected in the third stage is displayed in green, and the abnormal data detected in the fourth stage is displayed in red.

Here, in each of an NSL_KDD dataset and a CSE_CIC_IDS 2018 dataset, the types of abnormal data detected at each stage may be different from each other.

As illustrated in FIG. 8D, in the present disclosure, an abnormality rate (recall) detected in the NSL-KDD dataset is improved compared to the related art, anomaly detection accuracy (F1-score) is improved compared to the related art, and accuracy of all data is improved compared to the related art.

In addition, in the present disclosure, the abnormality rate (recall) detected in the CSE-CIC-IDS2018 dataset is improved compared to the related art, the anomaly detection accuracy (F1-score) is improved compared to the related art, and accuracy of all data is also improved compared to the related art.

That is, it is confirmed that the hierarchical network intrusion detection system 100 according to the embodiment of the present disclosure has better detection performance than the related art.

As described above, according to the present disclosure, by hierarchically using information of all hidden layers that compressively express the characteristics of network data, detection corresponding to the degree of abnormality of the network data may be performed, and whether an intrusion into the network data is detected is sequentially determined, and thus, efficiency may be improved.

As described above, according to the embodiment of the present disclosure, detection corresponding to the degree of abnormality in network data may be performed by hierarchically using information of all hidden layers that compressively represents characteristics of network data, and whether an intrusion into network data is detected is determined step by step, and thus, efficiency may be improved.

Although the present disclosure is described with reference to the embodiments illustrated in the drawings, which is merely examples, and it will be understood by those skilled in the art that various modifications and equivalent other embodiments are possible therefrom. Accordingly, the true technical protection scope of the present disclosure should be defined by the technical idea of the appended claims.

What is claimed is:

1. A hierarchical network intrusion detection method using a hierarchical network intrusion detection system based on hidden layer information of an autoencoder, the hierarchical network intrusion detection method comprising:
normalizing and preprocessing normal data for training in a state in which the normal data for training is collected;
outputting reconstruction data by inputting the preprocessed normal data for training into the autoencoder including an encoder and a decoder;
calculating a reconstruction error by using the preprocessed normal data for training and the reconstruction data;
training the autoencoder to minimize a reconstruction error value;
extracting hierarchical information of the trained autoencoder;
setting a threshold value for the normal data for training by using latent vector for the normal data for training, the reconstruction data, and an output value of each of L hidden layers included in the encoder;
calculating anomaly scores of the latent vector for the network data, the reconstruction data, and an output value of each of the L hidden layers included in the encoder in a state in which a target network data is input to the autoencoder; and
determining whether an intrusion into the network data is detected by using the threshold value and the anomaly scores.

2. The hierarchical network intrusion detection method of claim 1, wherein the outputting of the reconstruction data by inputting the preprocessed normal data for training into the autoencoder comprises:
outputting latent vector by inputting the preprocessed normal data for training into the encoder; and
outputting the reconstruction data by inputting the latent vector to the decoder.

3. The hierarchical network intrusion detection method of claim 1, wherein, in the calculating of the reconstruction error, the reconstruction error is calculated by using the preprocessed normal data for training for a training process, the reconstruction data of the decoder for the preprocessed normal data for training, and a mean squared error (MSE) loss function and by using an equation which is:
$$J ( {X}_{nor} , {\hat{X}}_{nor} ) = \frac{1}{N} {\sum }_{n = 1}^{N} {( {x}_{nor , n} - {\hat{x}}_{nor , n} )}^{2}$$
where, J is a loss function, Xₙₒᵣ is preprocessed normal data set for training, \tilde{X}ₙₒᵣ is the reconstruction data for a preprocessed normal dataset for training, N is the number of data samples of the normal dataset for training, x_{nor,n} is an N-th sample of Xₙₒᵣ, and \hat{x}_{nor,n} is an N-th sample of \hat{X}ₙₒᵣ.

4. The hierarchical network intrusion detection method of claim 1, wherein the training of the autoencoder comprises:
training the encoder by setting the preprocessed normal data for training as input data of the encoder and setting the latent vector as output data of the encoder;
training the decoder by setting the latent vector as input data of the decoder and setting the reconstruction data as output data of the decoder; and
training the autoencoder to minimize the reconstruction error value by using an error value between the preprocessed normal data for training and the reconstruction data.

5. The hierarchical network intrusion detection method of claim 1, wherein, in the setting of the threshold, based on the anomaly scores of the latent vector for the normal data for training, the reconstruction data, and the output value of each of the L hidden layers included in the encoder, the threshold value is set to minimize a fall-out rate for normal data for each of the other hidden layers except for a last L-th hidden layer among the L hidden layers included in the encoder, the threshold value is set to maximize a detection rate of abnormal data of the last L-th hidden layer.

6. The hierarchical network intrusion detection method of claim 1, wherein, in the calculating of the anomaly scores, the anomaly score of the latent vector for the network data is calculated by using an equation which is:
∈₁(x)= [symbol] _{MD}=\sqrt{(h−μₙₒᵣ)^{T}Σₙₒᵣ⁻¹(h−μₙₒᵣ)}
where ∈ is an anomaly score of randomly input network data, [symbol] _{MD} is a measurement value of Mahalanobis distance (MD), h is latent vector of an encoder for network data, μₙₒᵣ is an average of latent vector of an encoder to which normal data for training is input, Σₙₒᵣ is a latent vector covariance of normal data for training, and T denotes a transpose matrix.

7. The hierarchical network intrusion detection method of claim 1, wherein, in the calculating of the anomaly scores, the reconstruction error used to calculate the anomaly score of the reconstruction data for the network data is calculated by using an equation which is:
$${d}_{l} = \{ \begin{matrix}x - \hat{x} & ( l = 0 ) \\ {g}_{: l} ( x ) - {g}_{: l} ( \hat{x} ) & ( 0 < l \leq L )\end{matrix}$$
where dₗ is a reconstruction error used for calculating the anomaly score, l denotes a position at which the reconstruction error is obtained and denotes an output part of the decoder when l=0 and denotes l-th hidden layer part of the encoder when 0<l≤L, x is a preprocessed input data sample, \hat{x} is reconstruction data for x, and g_{:l} denotes calculation up to the l-th hidden layer.

8. The hierarchical network intrusion detection method of claim 7, wherein, in the calculating of the anomaly scores, variables for calculating the anomaly scores of the network data are calculated by using an equation which is:
D₀=Xₙₒᵣ−\hat{X}ₙₒᵣ
μ₀= [symbol] (D₀)
D̅₀=D₀− [symbol] _{N×1}×μ₀
D̅₀=U₀\tilde{Σ}₀V₀⁻¹
where, μ₀^{T} is an average of reconstruction errors corresponding to error values between input data for normal dataset for training and the reconstruction data, V₀ is a right singular vector obtained by performing a singular value decomposition calculation of D̅₀ that is linearly shifted such that an average of a reconstruction error D₀ of the normal dataset for training and a reconstruction dataset of the normal dataset for training becomes 0, and \tilde{Σ}₀⁻¹ denotes a singular value obtained by the singular value decomposition calculation, and
the variables are collected during extraction of the hierarchical information of the trained autoencoder.

9. The hierarchical network intrusion detection method of claim 8, wherein, in the calculating of the anomaly scores, the anomaly score of the output value of the decoder for the network data is calculated by using an equation which is:
∈₂(x)=L_{NL1}(d₀)=∥(d₀−μ₀^{T})^{T}V₀\tilde{Σ}₀⁻¹∥₁
where, [symbol] _{NL1} is a value measured by the normalized L1-norm method, d₀ is reconstruction errors corresponding to error values between network data and reconstruction data of the network data, and μ₀^{T} is an average of reconstruction errors corresponding to error values between input data of the normal dataset for training and reconstruction data.

10. The hierarchical network intrusion detection method of claim 1, wherein, in the calculating of the anomaly scores, variables for calculating the anomaly scores for the network data are calculated by using an equation which is:
Dₗ=g_{:l}(Xₙₒᵣ)−g_{:l}(\tilde{X}ₙₒᵣ)
μₗ= [symbol] (Dₗ)
D̅ₗ=Dₗ− [symbol] _{N×1}×μ₁
D̅ₗ=Uₗ\tilde{Σ}ₗVₗ⁻¹
where, μₗ^{T} is an average of reconstruction errors of the 1-th hidden layer for a normal dataset for training, Vₗ is a right singular vector obtained by performing a singular value decomposition calculation of D̅ₗ that is linearly shifted such that an average of reconstruction errors Dₗ of the 1-th hidden layer of a normal dataset for training becomes 0, and \tilde{Σ}ₗ⁻¹ denotes a singular value obtained by the singular value decomposition calculation, and
the variables are collected during extraction of the hierarchical information of the trained autoencoder.

11. The hierarchical network intrusion detection method of claim 10, wherein, in the calculating of the anomaly scores, the anomaly score of the output value of each of the L hidden layers included in the encoder for the network data is calculated by using an equation which is:
∈ₘ(x)=Σₗ₌₀^{m-2}L_{NL1}(dₗ)=Σₗ₌₀^{m-2}∥(dₗ−μₗ^{T})^{T}Vₗ\tilde{Σ}ₗ⁻¹∥₁
where, m is a value greater than or equal to 3, dₗ is a reconstruction error corresponding to an error value between an output value output from the l-th hidden layer when network data is input to an encoder and an output value output from the l-th hidden layer when reconstruction data is input to the encoder, and μₗ^{T} is an average of reconstruction errors of the l-th hidden layer for normal dataset for training.

12. The hierarchical network intrusion detection method of claim 1, wherein, in determining whether the intrusion is detected,
when the anomaly scores of the latent vector, the reconstruction data, and the network data in each of the L hidden layers included in the encoder are greater than the threshold value for the normal data for training, the network data is detected as abnormal data,
when the anomaly score of the network data in the latent vector is less than or equal to the threshold value set through the latent vector, moving to the decoder is performed,
when the anomaly score of the network data in the reconstruction data is higher than the threshold value set through the reconstruction data, moving to the l-th hidden layer included in the encoder is performed,
when the anomaly score of the network data in l-th hidden layer is less than or equal to the threshold value in the l-th hidden layer, moving to l+1-th hidden layer included in the encoder is performed, and
the anomaly scores are compared with the threshold value for each of the L hidden layers included in the encoder to sequentially determine whether an intrusion into the network data is detected.

13. The hierarchical network intrusion detection method of claim 12, wherein, in determining whether the intrusion is detected, the network data is determined as normal only when the anomaly score of the network data in the last L-th hidden layer among the L hidden layers included in the encoder is less than or equal to the threshold value in the last L-th hidden layer.

14. A hierarchical network intrusion detection system based on hidden layer information of an autoencoder comprising:
a preprocessor configured to normalize and preprocess normal data for training in a state in which the normal data for training is collected;
a training unit configured to output reconstruction data by inputting the preprocessed normal data for training into the autoencoder including an encoder and a decoder, calculate a reconstruction error by using the preprocessed normal data for training and the reconstruction data, and train the autoencoder to minimize a reconstruction error value;
a setting unit configured to extracting hierarchical information of the trained autoencoder and set a threshold value for the normal data for training by using latent vector for the normal data for training, the reconstruction data, and an output value of each of L hidden layers included in the encoder;
a calculation unit configured to calculate anomaly scores of the latent vector for the network data, the reconstruction data, and an output value of each of the L hidden layers included in the encoder in a state in which a target network data is input to the autoencoder; and
a control unit configured to determine whether an intrusion into the network data is detected by using the threshold value and the anomaly scores.

15. The hierarchical network intrusion detection system of claim 14, wherein the setting unit sets the threshold value to minimize a fall-out rate for normal data for each of the other hidden layers except for a last L-th hidden layer among the L hidden layers included in the encoder, and sets the threshold value to maximize a detection rate of abnormal data of the last L-th hidden layer, based on the anomaly scores of the latent vector for the normal data for training, the reconstruction data, and the output value of each of the L hidden layers included in the encoder.

16. The hierarchical network intrusion detection system of claim 14, wherein the calculation unit, calculates the anomaly score of the latent vector for the network data by using an equation which is:
∈₁(x)= [symbol] _{MD}=\sqrt{(h−μₙₒᵣ)^{T}Σₙₒᵣ⁻¹(h−μₙₒᵣ)}
where ∈ is an anomaly score of randomly input network data, [symbol] _{MD} is a measurement value of Mahalanobis distance (MD), h is latent vector of an encoder for network data, μₙₒᵣ is an average of latent vector of an encoder to which normal data for training is input, Σₙₒᵣ is a latent vector covariance of normal data for training, and T denotes a transpose matrix.

17. The hierarchical network intrusion detection system of claim 14, wherein the reconstruction error used to calculate the anomaly score of the reconstruction data for the network data is calculated by using an equation which is:
$${d}_{l} = \{ \begin{matrix}x - \hat{x} & ( l = 0 ) \\ {g}_{: l} ( x ) - {g}_{: l} ( \hat{x} ) & ( 0 < l \leq L )\end{matrix}$$
where dₗ is a reconstruction error used for calculating the anomaly score, l denotes a position at which the reconstruction error is obtained and denotes an output part of the decoder when l=0 and denotes l-th hidden layer part of the encoder when 0<l≤L, x is a preprocessed input data sample, \hat{x} is reconstruction data for x, and g_{:l} denotes calculation up to the l-th hidden layer.

18. The hierarchical network intrusion detection system of claim 14, wherein variables for calculating the anomaly scores for the network data are calculated by using an equation which is:
Dₗ=g_{:l}(Xₙₒᵣ)−g_{:l}(\tilde{X}ₙₒᵣ)
μₗ= [symbol] (Dₗ)
D̅ₗ=Dₗ− [symbol] _{N×1}×μ₁
D̅ₗ=Uₗ\tilde{Σ}ₗVₗ⁻¹
where, μₗ^{T} is an average of reconstruction errors of the l-th hidden layer for a normal dataset for training, Vₗ is a right singular vector obtained by performing a singular value decomposition calculation of D̅ₗ that is linearly shifted such that an average of reconstruction errors Dₗ of the l-th hidden layer of a normal dataset for training becomes 0, and \tilde{Σ}ₗ⁻¹ denotes a singular value obtained by the singular value decomposition calculation, and
the variables are collected during extraction of the hierarchical information of the trained autoencoder.

19. The hierarchical network intrusion detection system of claim 18, wherein the anomaly score of the output value of each of the L hidden layers included in the encoder for the network data is calculated by using an equation which is:
∈ₘ(x)=Σₗ₌₀^{m-2}L_{NL1}(dₗ)=Σₗ₌₀^{m-2}∥(dₗ−μₗ^{T})^{T}Vₗ\tilde{Σ}ₗ⁻¹∥₁
where, m is a value greater than or equal to 3, dₗ is a reconstruction error corresponding to an error value between an output value output from the l-th hidden layer when network data is input to an encoder and an output value output from the l-th hidden layer when reconstruction data is input to the encoder, and μₗ^{T} is an average of reconstruction errors of the l-th hidden layer for normal dataset for training.
